(19) United States
(12) Patent Application Publication
(10) Pub. No.: US 2020/0360223 A1
(43) Pub. Date: Nov. 19, 2020

(54) PNEUMATIC INFLATABLE REHABILITATION DEVICE

(71) Applicant: Seoul National University R&DB Foundation, Seoul (KR)

(72) Inventors: Yong-lae PARK, Seoul (KR); Se-hun PARK, Seoul (KR); Dong-wook KIM, Suwon-si (KR); Jae-hyun YI, Seoul (KR)

(21) Appl. No.: 16/846,794

(22) Filed: Apr. 13, 2020

(30) Foreign Application Priority Data
Apr. 12, 2019 (KR) 10-2019-0043365
Oct. 30, 2019 (KR) 10-2019-0136750

(51) Int. Cl. A61H 9/00; A61H 1/02

(52) U.S. Cl. CPC A61H 9/0092; A61H 1/0274; A61H 2201/165; A61H 2201/1635; A61H 2201/1238

(57) ABSTRACT

Disclosed is a pneumatic inflatable rehabilitation device including a first fixing band mounted on an upper part of a forearm, a second fixing band mounted on a lower part of the forearm, and at least one rehabilitation band having one side and the other side mounted between the first fixing band and the second fixing band and wound around the forearm at least once.

This application claims priority to Korean Patent Application Nos. 10-2019-0043365, filed on Apr. 13, 2019, and 10-2019-0136750, filed on Apr. 13, 2019, in the Korean Intellectual Property Office, the disclosures of which are incorporated by reference herein in their entireties.

### TECHNICAL FIELD

The present disclosure relates to a pneumatic inflatable rehabilitation device, and more particularly, to a wearable pneumatic inflatable rehabilitation device for rehabilitation of a forearm for pronation and supination.

### DISCUSSION OF THE RELATED ART

A disorder of a forearm, which is a lower arm in an arm, may come from numerous diseases or injuries, such as stroke, spinal cord injury (SPI), acquired or traumatic brain injury (ABI/TBI), fractures, and injuries with incisions or holes.

For patients with forearm problems due to such a forearm disorder, daily movements such as drinking water or wearing clothes are no longer normal movements.

Therefore, those patients with a forearm disorder suffer a lot of pain in everyday life and many rehabilitation motions to overcome the forearm disorder are important.

However, since most of the generally available rehabilitation devices are bulky, heavy, and expensive, many patients with forearm disabilities may not afford rehabilitation devices to install them in their homes and continue to manage them at home.

Therefore, most of the patients with forearm disabilities have to visit a nearby hospital or clinic to perform rehabilitation motions, so it takes a lot of time and money and patients with poor mobility have a lot of difficulty and inconvenience in rehabilitation motions.

Currently, one of the rehabilitation exercises for forearm disorders is assisted arm training using a robot, which is widely used these days and is effective in improving an exercise function of patients.

A general rehabilitation mechanism using an existing robot is that, while a patient is holding a handle of the robot, an assistive force or resistive force that helps to recover a function of the patient's forearm muscles is applied to the patient's forearm through the robot.

Most of the robot rehabilitation devices using such a robot are formed of rigid materials such as metal, and thus, the devices are heavy in weight and costly.

### SUMMARY

An aspect of the present disclosure is to facilitate rehabilitation of a patient with forearm disorders.

Another aspect of the present disclosure is to improve the convenience of patients by freeing the forearm disorder regardless of time and place.

Another aspect of the present disclosure is to perform a rehabilitation motion of a forearm at low cost.

Another aspect of the present disclosure is to improve wearability and increase convenience of mounting.

Another aspect of the present disclosure is to provide a safe and compact rehabilitation device for forearm rehabilitation.

In an aspect, a pneumatic inflatable rehabilitation device includes: a first fixing band mounted on an upper part of a forearm; a second fixing band mounted on a lower part of the forearm; and at least one rehabilitation band having one side and the other side mounted between the first fixing band and the second fixing band and wound around the forearm at least once.

The rehabilitation band may include a body filled with air injected from the outside; and an attachment portion located at opposing ends of the body and mounted at each of the first and second fixing bands.

The body may include a plurality of air chambers partitioned along a longitudinal direction and each filled with air.

Two adjacent air chambers may be connected to each other.

An end of the attachment portion may have a diagonal structure.

The opposing ends of the body may have an oblique structure.

The attachment portion may have a Velcro structure.

The rehabilitation band may further include an air injection port connected to one side of the body.

The rehabilitation band may include two rehabilitation bands.

The first fixing band and the second fixing band may each include a body and a fixing portion connected to an end of the body.

The body of each of the first fixing band and the second fixing band may include an anti-slip pad.

Each of outer surfaces of the body of the first fixing band and the body of the second fixing band may have a Velcro structure.

The fixing portion of the first fixing band and the fixing portion of the second fixing band may each include a fixing strap and a fixing ring coupled to the fixing strap.

The pneumatic inflatable rehabilitation device may include fabric.

According to the features, since the pneumatic inflatable rehabilitation device has an atypical geometric structure, which is a bionic structure, wearability and discomfort at the time of motion may be significantly reduced, thereby increasing user's satisfaction and significantly reducing a risk of injury in case of malfunction.

In addition, since the pneumatic inflatable rehabilitation device is formed of a lightweight fabric, it may be easily worn on or removed and discomfort due to weight when worn is significantly reduced. In addition, manufacturing costs are also significantly reduced, reducing a financial burden of users.

Moreover, since the pneumatic inflatable rehabilitation device of this embodiment is a pneumatic type using air, it is light even when used and does not cause much pain, and a risk of injury in case of malfunction is significantly reduced.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIGS. 1A and 1B are views of a pneumatic inflatable rehabilitation device according to an embodiment of the present disclosure, wherein FIG. 1A is a view showing front and rear portions of a first fixing band and a second fixing band, and FIG. 1B is a view showing front and rear portions of a rehabilitation band when air is exhausted.

FIGS. 2A, 2B, 2C, and 2D are views showing a state in which a pneumatic inflatable rehabilitation device is worn on a forearm of a rehabilitating person according to an embodiment of the present disclosure, wherein FIG. 2A shows a state in which a first fixing band and a second fixing band are worn on an upper part and a lower part of a forearm, respectively, FIG. 2B shows a state in which a first rehabilitation band is worn on the first fixing band and the second fixing band in the case of pronation, FIG. 2C shows a state in which a second rehabilitation band is worn on the first fixing band and the second fixing band in the case of supination, and FIG. 2D shows a state of a rehabilitation band actually worn on a forearm of a user.

FIGS. 3A and 3B are views showing a state in which a pneumatic inflatable rehabilitation device is mounted on an arm model according to an embodiment of the present disclosure, wherein FIG. 2A shows a contraction direction of a rehabilitation band and FIG. 2B shows a rotation direction of an arm.

FIG. 4 is a view showing an operation mechanism of rotation before contraction (area AR13) and after contraction (area AR14) in a pneumatic inflatable rehabilitation device according to an embodiment of the present disclosure.

FIG. 5 is a view showing a motorized three-axis stage and a heat application unit for heat sealing of a pneumatic inflatable rehabilitation device according to an embodiment of the present disclosure, in which a spherical rollerball tip (4.95 mm) is mounted to a soldering iron with an adapter formed of copper.

FIG. 6 is a graph defining a first peak of a peeling test for a pneumatic inflatable rehabilitation device according to an embodiment of the present disclosure, in which a first peak value of a load indicates a quality characteristic value which is a time when inflatability loses its functionality.

FIGS. 7A and 7B show an S/N ratio for a first test setting and an S/N ratio for a second test setting, respectively, in which circles represent the highest S/N ratio based on each parameter.

FIG. 8 is a graph showing a force-length relationship in a rehabilitation band having different pressure levels according to an embodiment of the present disclosure.

FIG. 9 is a view showing a characterization test setup of a pneumatic inflatable rehabilitation device according to an embodiment of the present disclosure.

FIG. 10 is a graph showing rotation angle over torque in a rehabilitation band having various pressure levels according to the present embodiment.

FIG. 11 is a view illustrating a test setup for a rehabilitation band according to an embodiment of the present disclosure, specifically, illustrating a test setup for closed loop control using a vision system.

FIG. 12 is a graph showing a result of closed loop angle control of an arm model wearing a pneumatic inflatable rehabilitation device according to an embodiment.

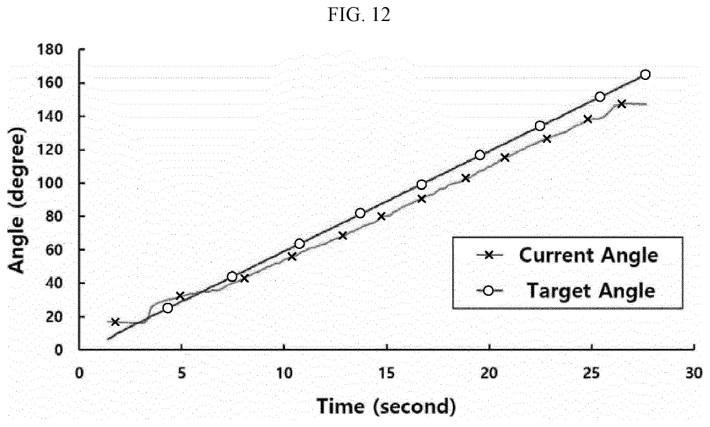

### DETAILED DESCRIPTION OF EXEMPLARY EMBODIMENTS

Hereinafter, embodiments of the present invention will be described in detail with reference to the accompanying drawings. In describing the present invention, if it is determined that a detailed description of known functions and components associated with the present invention unnecessarily obscure the gist of the present invention, the detailed description thereof will be omitted. The terms used henceforth are used to appropriately express the embodiments of the present invention and may be altered according to a person of a related field or conventional practice. Therefore, the terms should be defined on the basis of the entire content of this specification.

Technical terms used in the present specification are used only in order to describe specific exemplary embodiments rather than limiting the present invention. The terms of a singular form may include plural forms unless referred to the contrary. It will be further understood that the terms “comprise” and/or “comprising,” when used herein, specify the presence of stated features, integers, steps, operations, elements, and/or components, but do not preclude the presence or addition of one or more other features, regions, integers, steps, operations, elements, components, and/or groups thereof.

Hereinafter, a pneumatic inflatable rehabilitation device according to an embodiment of the present disclosure will be described with reference to the accompanying drawings.

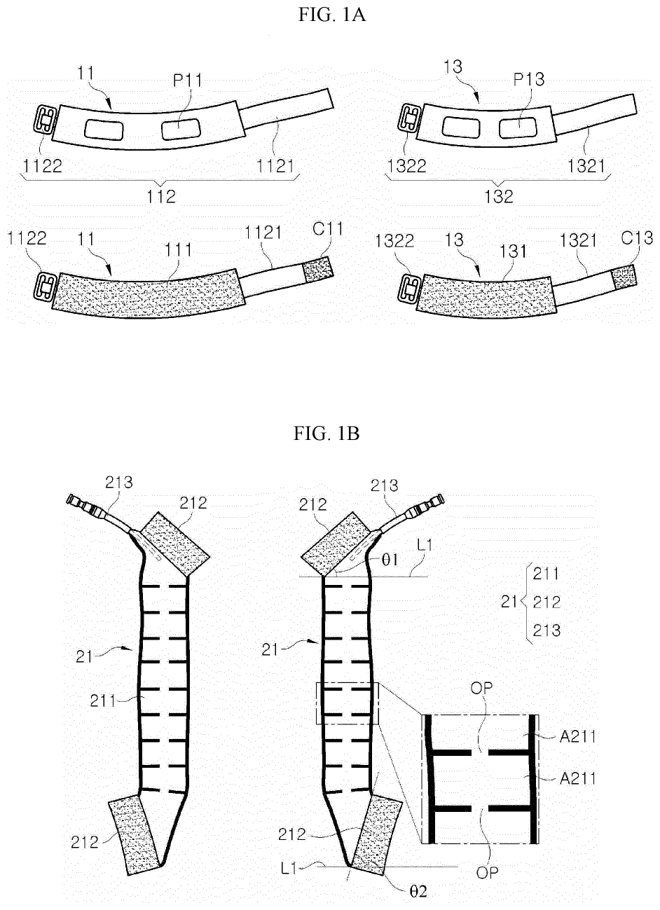

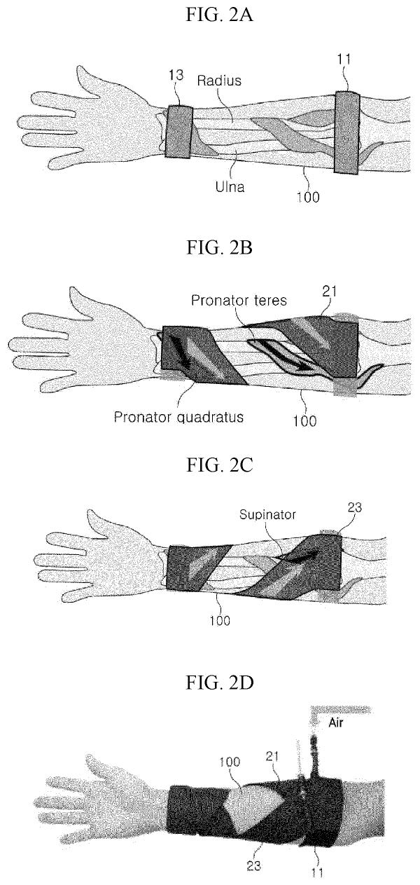

First, referring to FIGS. 1 and 2, a pneumatic inflatable rehabilitation device according to this embodiment (hereinafter, the pneumatic inflatable rehabilitation device will be referred to as a “rehabilitation device”) may include a first fixing band 11, a second fixing band 13, and at least one rehabilitation band (e.g., a first rehabilitation band and a second rehabilitation band) 21 and 23 attached (or fastened) to the first band 11 and the second band 13.

As shown in FIG. 2A, the first fixing band 11 is a band mounted on an upper part (i.e., a portion adjacent to an elbow) of a forearm 100 of a user, i.e., a rehabilitating person, where the first and second rehabilitation bands 21 and 23 are attached.

Since the first fixing band 11 is mounted to wind around the corresponding forearm 100 of the rehabilitating person in a circumferential direction, the first fixing band 11 has a long strip shape.

Accordingly, the first fixing band 11 includes a body 111 having a long strip shape and fixing portions 112 located at opposing ends of the body 111.

The body 111 is a part mainly surrounding the upper part of the forearm 100 of the rehabilitating person, and an inner surface, i.e., a surface wound around the forearm 110 of the rehabilitating person, may have at least one a non-slip pad P11 containing a synthetic resin material such as silicone.

As shown in FIG. 1, in one example, two anti-slip pads P11 may be attached to the corresponding surface of the body 111, and here, the two anti-slip pads P11 may be located abreast and spaced apart from each other in a longitudinal direction.

In addition, an outer surface of the body 111, which is a surface opposite to the inner surface and exposed to the outside, has a Velcro structure and may be easily and quickly combined with the first and second rehabilitation bands 21 and 23.

The fixing portion 112 serves to stably maintaining a state of the first fixing band 11 wound around the corresponding portion of the forearm 100.

The fixing portion 112 may include a fixing strap 1121 and a fixing ring 1122 coupled to the fixing strap 1121.

Therefore, the rehabilitating person or a guardian may insert the fixing strap 1121 into the fixing ring 1122 so that the wound state of the first fixing band 11 may be maintained.

However, the structure of the fixing portion 112 is not limited to this embodiment and may have various other forms such as a Velcro structure (i.e., a hook and loop structure) or a 3-glide buckle.

As shown in FIG. 1, an end portion of the outer surface of the fixing strap 1121 may have an attachment portion C11 having a Velcro structure to facilitate attachment to and detachment from the outer surface of the body 111 having a Velcro structure.

As shown in FIG. 2A, the second fixing band 13 is mounted on a lower part (i.e., a part adjacent to a hand) of the forearm 100 of the rehabilitating person opposite to the mounting part of the first fixing band 11 to oppose the first fixing band 11 mounted at the upper part of the forearm 100 of the rehabilitating person.

The second fixing band 13 has the same structure as the first fixing band 11 except for a difference in extension length according to a mounting position different from the first fixing band 11.

Accordingly, the second fixing band 13 includes a body 131 having a long strip shape and a fixing portion 132 located at opposing ends of the body 121.

The body 121 also has the same shape as the body 111 of the first fixing band 11, except for the extension length different from the body 110 of the first fixing band 11, and includes at least one attachment pad P13 attached to an inner surface thereof.

The at least one attachment pad P13 may also include a synthetic resin such as silicone and serves to improve adhesion with a corresponding part of the rehabilitating person.

An outer surface of the body 121 of the second fixing band 13 may also have a Velcro structure for coupling with the first and second rehabilitation bands 21 and 23.

The fixing portion 132 may also include a fixing strap 1321 and a fixing ring 1322 in the same manner as the first fixing band 11, but is not limited thereto.

An end portion of the fixing strap 1321 may also have an attachment portion C13 attached to and detached from an outer surface of the second fixing band 13.

As an example, the first fixing band 11 and the second fixing band 13 may be formed by synthesizing polyester (88%) and polyurethane fiber (e.g., spandex (12%)) and may have a weight of 460 g/yd.

The first and second rehabilitation bands 21 and 23 may be formed of a durable fabric which does not have air penetration through attachment, sweat, or the like, has high burst strength, and is not torn even by frequent inflation due to an injection operation of air.

For example, the first and second rehabilitation bands 21 and 23 may be formed of heat-sealable ripstop fabric obtained by synthesizing ripstop fabric and nylon.

The first rehabilitation band 21 and the second rehabilitation band 23 may have the same structure and may be worn on a corresponding body part in a horizontally inverted form as shown in FIG. 2.

The first and second rehabilitation bands 21 and 23 are each wound around the forearm 100 of the rehabilitating person in opposite directions in a spiral shape, one end thereof is attached to the first fixing band 11 and the other end thereof is attached to the second fixing band 13, thus being fixed in position.

For example, the first rehabilitation band 21 may be wound around the forearm 100 in a spiral form in a right direction as shown in FIG. 2B, and the second rehabilitation band 23 may be wound around the forearm 100 in the spiral form in a left direction opposite to the winding direction of the first rehabilitation band 21 as shown in FIG. 2C.

The first and second rehabilitation bands 21 have the same structure as described above. For example, the first rehabilitation band 21 may have a body 211, an attachment portion 212 located at opposing ends of the body 211, and an air injection port 213 connected to one end of the attachment portion 212.

The body 211 of the first rehabilitation band 21 has an empty space therein and serves as a single air bag filled with air introduced through the air injection port 212. The body 211 has a long extended band shape and has a single connected empty space therein.

Here, the body 211 is partitioned along a longitudinal direction and divided into a plurality of air chambers A211, so that each air chamber A211 may function as one small air bag.

Here, each air chamber A211 is surrounded by upper, lower, and side portions.

As shown in FIG. 1, the side portions of all the air chambers A211 are blocked. Edge portions of the upper end and the lower end connected to a portion (e.g., side portion) are attached, while a middle portion thereof is not attached but open to provide an opening OP. Accordingly, two air chambers A211 adjacent to each other are connected to each other through the non-attached opening OP and air flow between the two adjacent air chambers A211 is achieved.

Here, one ends (i.e., lower and upper ends) the first chamber A211 of the body 211 abut on the attachment portion 212 of the first rehabilitation band 21 and one end (i.e., the lower and upper ends) of the first air chamber A211 are completely attached so that air introduced through the air injection port 213 is prevented from being discharged to the outside of the first rehabilitation band 21 without passing through the air injection port 213.

In this embodiment, in order to form the air chamber A211 inside the body 211, the corresponding space may be separated through a heat sealing operation.

Since the opposing ends of the body 211 of the first rehabilitation band 21 has an oblique shape, the first air chamber A211 and the last air chamber A211 have a triangular planar shape and the other remaining air chambers A211 may have a rectangular planar shape having the open portions OP at the middle portions of the upper and lower ends as shown in FIG. 1A.

Here, the angles 81 and 82 formed by a horizontal line L1 and the oblique line are different from each other. The angle 81 formed by the end of the body 211 located at the upper portion of the forearm of the rehabilitating person may be smaller than the angle 82 formed by the end of the body 211 located at the lower portion of the forearm. In this embodiment, the horizontal line L1 is a straight line extending in a direction perpendicular to the extension direction of the body 211.

As described above, since opposing ends of the body 211 are inclined, the attachment portion 232 having a substantially rectangular planar shape attached thereto is also inclined with respect to the horizontal line L1 in the same manner as the corresponding end of the body 211.

Therefore, an outer end of the attachment portion 212 attached to the first and second fixing bands 11 and 13 (i.e., the opposite end of the inner end connected to the body 211) also has an oblique structure, and thus the rehabilitating person may more easily and efficiently attach the corresponding rehabilitation band 21 to the first and second fixing portions 112 and 132.

The attachment portions 212 respectively located at the opposing ends, i.e., the upper end and the lower end, of the first rehabilitation band 21 are portions attached to the corresponding positions of the first and second fixing bands 11 and 13, respectively. The attachment portions 212 are attached to the outer surfaces of the first and second fixing bands 11 and 13, respectively.

Therefore, as an example, the attachment portion 212 of the first rehabilitation band 21 may have a Velcro structure which can be easily attached to and detached from the first fixing band 11 and the second fixing band 13 having a Velcro structure.

The air injection port 213 of the first rehabilitation band 21 is a part into which air is injected from the outside, and is connected to the corresponding air chamber (e.g., the first air chamber) A211 of the body 211, so that air may be injected to and discharged from the corresponding air chamber A211.

Here, a blocking member (not shown) may be located at the air injection port 213 to prevent air injected into the body 211 from being discharged to the outside regardless of the user's intention.

Therefore, when an air injection pipe of an air pump (not shown) is inserted into the air injection port 213 to inject air into the body 211 of the first rehabilitation band 21, the air injection pipe may push the blocking member and the blocking member may be opened by force. Accordingly, air discharged from the air pump passes through the opened blocking member to inject air into the first air chamber A211 of the body 211, and air is sequentially injected into the other remaining air chambers A211 connected to each other in series through the opening OP, so that all the air chambers A211 may be inflated and contracted almost simultaneously.

However, when the air injection pipe of the air pump is removed from the blocking member, a position of the blocking member returns to its initial position due to a restoring force of the blocking member to maintain the initial closed state. Accordingly, the air located in the body 211 is not discharged to the outside.

Here, in order to discharge the air inserted into the body 211 of the first rehabilitation band 21, a guardian or the rehabilitating person may press the body 211 by hand to forcefully open the blocking member to discharge air to the outside.

In order to mount the pneumatic inflatable rehabilitation device of this embodiment having such a structure on the forearm 100 of the corresponding arm, first, the first fixing band 11 and the second fixing band 13 are wound around the upper portion and the lower end of the forearm 100 as shown in FIG. 2A.

The mounting state of the first and second fixing bands 11 and 13 may be adjusted by adjusting lengths of the fixing straps 1121 and 1321 according to a circumference of the forearm of the rehabilitating person.

Next, as shown in FIG. 2B, the end of one (e.g., the first rehabilitation band 21) of the first rehabilitation band 21 and the second rehabilitation band 23 is attached to an outer surface of one (e.g., the first fixing band 21) of the first fixing band 21 and the second fixing band 23, the first rehabilitation band 21 is subsequently wound in a spiral shape along the corresponding direction (right direction), and the end of the other is attached to the outer surface of the other fixing band (e.g., the second fixing band 23).

Thereafter, as shown in FIG. 2C, the end of the other (e.g., the second rehabilitation band 23) of the first rehabilitation band 21 and the second rehabilitation band 23 is also attached to the outer surface of one (e.g., the first fixing band 11) of the first fixing band 11 and the second fixing band 13, the second rehabilitation band 23 is subsequently wound in a spiral shape along the corresponding direction (e.g., left direction), and the other end is attached to the outer surface of the other second fixing band (e.g., 13) so as to be mounted on the forearm 100 of the rehabilitating person in such a form as shown in FIG. 2D.

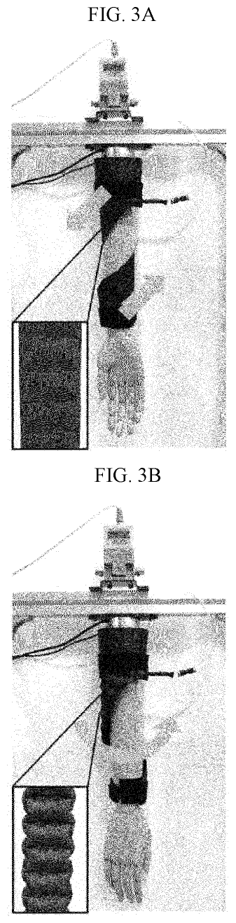

As such, a shape in which air is not injected after the rehabilitation device of this embodiment is mounted on the forearm 100 of the rehabilitating person may be as shown in FIG. 3A.

In this state, air is injected into the respective air chambers A211 and A221 in the bodies 211 and 221 through the air injection ports 213 and 233 of the first rehabilitation band 21 and the second rehabilitation band 23. Due to the air injection, the first rehabilitation band 21 and the second rehabilitation band 23 apply pressure to the corresponding part of the forearm 100 being wound as shown in FIGS. 2B and 2C to perform rehabilitation motion such as contraction exercise of corresponding muscles. As such, a shape in which air is injected after the rehabilitation device of this embodiment is mounted on the forearm 100 of the rehabilitating person may be as shown in FIG. 3B.

As such, when air is injected into the first rehabilitation band 21 and the second rehabilitation band 23, the first rehabilitation band 21 and the second rehabilitation band are contracted in an axial direction like human biological muscles by radial expansion as shown in FIG. 3B.

As such, the first rehabilitation band 21 and the second rehabilitation band 23 have an ergonomic design and may be designed based on the two arm muscles, i.e., supinator teres attached to lateral epicondyle and radius and pronator teres attached to medial epicondyle and radius.

Therefore, the first rehabilitation band 21 and the second rehabilitation band 23 perform the functions of the two muscles described above, i.e., the supinator teres and the pronator teres according to the attached portion, as well as the rehabilitation motion of the forearm 100.

Based on the winding direction of the first rehabilitation band 21 and the second rehabilitation band 23, the forearm 100 is supinated or rotated when the first rehabilitation band 21 and the second rehabilitation band 23 are contracted.

The human muscles are attached to a solid part (e.g., bone) of the corresponding part and are covered with skin, while the first rehabilitation band 21 and the second rehabilitation band 23 of this embodiment are located on the skin. Therefore, for this reason, the first and second rehabilitation bands 21 and 23 of the present embodiment needs to be thin unlike human muscles because compression of a bulky rehabilitation band causes discomfort in the forearm.

Therefore, the flat pneumatic actuator formed of fabric of the present embodiment, i.e., the first and second rehabilitation bands 21 and 23, may be selected from the McKibben muscle.

Along with the selection of the McKibben muscle, the skin to which the first and second rehabilitation bands 21 and 23 are attached based on the bone must be stretched or rotated based on the bone, so an anchoring method is also very important.

The first rehabilitation band 21 and the second rehabilitation band 23 may be formed of a fabric material which has good wearability and is easy to manufacture using various medical manufacturing technologies.

For example, the first fixing band 11 and the second fixing band 13 may contain a lightweight synthetic resin material and may be formed of a double layer to have good rigidity. In addition, the first fixing band 11 and the second fixing band 13 may have good breathability.

As shown in FIG. 2B again, air is injected into the first rehabilitation band 21 so that the first rehabilitation band 21 is contracted in a winding direction which is a direction indicated by the arrow (i.e., the right arrow in FIG. 2B), pressure is applied to the pronator teres and pronator quadratus formed in the same direction as the first rehabilitation band 21 and contraction is made in the same spiral direction as the contraction direction of the corresponding first rehabilitation band 21 as indicated by the arrow (the left arrow in FIG. 2B). As a result, a torsional motion of the pronator teres and the pronator quadratus is performed.

In addition, as shown in FIG. 2C, air is injected into the second rehabilitation band 23 so that the second rehabilitation band 23 is contracted in a winding direction which is a direction indicated by the arrow (i.e., the right arrow in FIG. 2C), pressure is applied to the supinator formed in a direction similar to that of the second rehabilitation band 23 and contraction is made in the same spiral direction as the contraction direction of the corresponding second rehabilitation band 23 as indicated by the arrow (i.e., the left arrow in FIG. 2C). As a result, a torsional motion of the supinator is performed.

In this way, since the corresponding muscles are contracted by the air injected into the first rehabilitation band 21 and the second rehabilitation band 23, the rehabilitating person may perform a rehabilitation exercise of the forearm 100 without great pain, resulting in a user's satisfaction.

In addition, since the first rehabilitation band 21 and the second rehabilitation band 23 are ergonomically designed, the first rehabilitation band 21 and the second rehabilitation band 23 are contracted in the direction of muscle formation, thus assisting the motion of the corresponding muscles, as well as the rehabilitation motion of the muscles. Therefore, when performing daily life after wearing the rehabilitation device of the present embodiment, the rehabilitating person may more easily live his or her life, and thus the convenience of the rehabilitating person is improved.

In addition, since both the first and second fixing bands 11 and 13 and the first and second rehabilitation bands 21 and 23 are formed of elastic and lightweight fabric, when the rehabilitating person wears the rehabilitation device of this embodiment, he or she may not feel great discomfort in exercise motion or in life, and since the rehabilitation device is easily portable, the rehabilitating person may perform the rehabilitation exercise of the forearm 100 regardless of time and place.

In this embodiment, two rehabilitation bands 21 and 23 are provided, but the present disclosure is not limited thereto and one rehabilitation band may be provided.

In general, a range of the pronation and supination of the forearm 100 for an extended heel position is about 160 degrees, so the first rehabilitation band 21 and the second rehabilitation band 23 also need to have this rotation range (about 160 degrees).

A contraction ratio of a typical pneumatic artificial muscle may be about 10% to 30%, and here, if the forearm length Lf is fixed between opposing ends of each of the rehabilitation bands 21 and 23, a relatively large rotation angle may be provided.

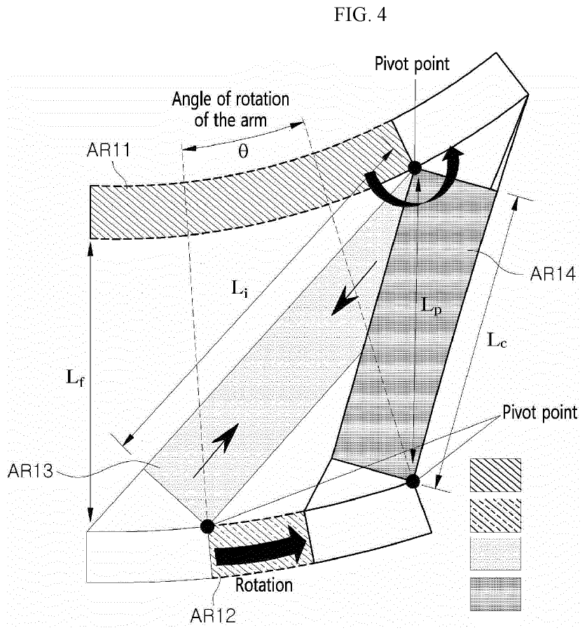

Accordingly, FIG. 4 is a conceptual diagram of an operation of a flat pneumatic actuator (e.g., a rehabilitation band in this embodiment) based on the assumption that the forearm is a truncated cone.

In FIG. 4, a first area AR11 having a small radius represents a wrist, and a second area AR12 having a large radius represents an elbow.

A third area AR13 is a rehabilitation band of the present embodiment which is an actuator contracted when air is discharged, and a fourth area AR14 is an actuator inflated when air is injected.

Two pivot points of the actuator act as hinges.

When the actuator is contracted (i.e., when air is injected into the rehabilitation band), the forearm is rotated in the direction indicated by the arrow in FIG. 3A due to the inflation operation of the rehabilitation band to shorten an initial length Li of the actuator and rotation is performed in the direction of the arrow as shown in the rehabilitation band (b) until a length Lp between the two pivot points is equal to the forearm length Lf. When design factors such as a contraction rate and arm circumference are given, any range of motion may be determined based on simple geometric calculations.

When the air injected into the rehabilitation band is discharged, the pressure of the rehabilitation band surrounding the forearm is released, and thus the state of the forearm is returned to the initial position as shown in FIG. 3A.

Accordingly, as the operation of injecting air into and discharging air from the rehabilitation band is repeated, the rotation and returning operation of the forearm are automatically performed so that the rehabilitation motion of the forearm is performed.

Here, if a pulling force of the fixing band increases, the fixing band may slide on the forearm part to interfere with the operation of the actuator (i.e., the rehabilitation band).

Therefore, in order to avoid such undesired sliding of the fixing band, the number of windings of the rehabilitation band may be increased to reduce the angle between the rehabilitation band and the fixing band.

However, if the number of windings of the rehabilitation band spirally wound around the forearm 100 is increased, the rehabilitating person may feel uncomfortable. Thus, in this embodiment, the rehabilitation band performs one winding operation at 360 degrees, but is not limited thereto. That is, the number of windings of the rehabilitation band wound around the forearm 100 may be multiple times, and accordingly, the rotation angle of the rehabilitation band wound around the forearm 100 may exceed 360 degrees.

In addition, as the contraction rate of the rehabilitation band is greater, the forearm rotates more when the rehabilitation band operates in the same manner.

Therefore, in order to increase the contraction rate of the rehabilitation band, a width and a length of each of the air chambers A211 and A221, which are single chambers, need to be large. However, a size of the single chamber also determines a size of the corresponding rehabilitation band, which affects wearability.

In order to achieve a contraction rate of 25% and wearability, each air chamber A211 may have a width of 20 to 30 mm and a length of 40 to 50 mm, and the rehabilitation bands 21 and 23 may have nine air chambers A211, for example.

The rehabilitation device of this embodiment may be manufactured by constructing an automated manufacturing system for product reliability, product consistency, and durability. Accordingly, it is possible to maintain robustness and consistency of the rehabilitation device of this embodiment.

In addition, in order to manufacture the rehabilitation bands 21 and 23 having a plurality of air chambers A211 and the fixing bands 11 and 13, various heat sealing such as manual patterning, heat press, and automatic patterning may be used.

The manual patterning, which is manual sealing, is simple and advantageous in terms of cost because quality of a product is determined mainly by personal skill of an operator and does not require a complex system for sealing.

However, sometimes it takes a lot of manufacturing time and quality of a finished product is not guaranteed.

The heat press is more stable in sealing the same product using a thermally conductive stencil. However, it is not efficient if a sealing pattern is frequently changed.

Compared to the above two methods, automatic patterning is the most effective heat sealing method for manufacturing products at high speed. Generally, a heat applicator (e.g., an iron) is used as an end-effector of a motorized x-y-z stage to draw a sealing pattern with a simple two-dimensional (2D) sketch. This method eliminates the need to prepare heavy and bulky stencil. Therefore, in this embodiment, automatic patterning may be employed to manufacture a rehabilitation device having a relatively complex pattern, in particular, the rehabilitation bands 21 and 23.

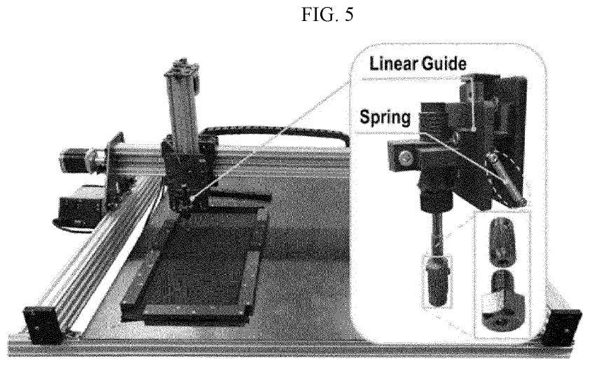

In an automated manufacturing system for manufacturing the rehabilitation device of this embodiment, an iron equipped with a spherical rollerball tip may be mounted on a three-axis motorized stage for heat sealing with a working space of 950 mm×900 mm, as shown in FIG. 5. A rollerball tip having an about 4.95 mm diameter may facilitate smooth motion of the end effector by minimizing a dragging force, while drawing a pattern.

Positions of the x-coordinate (i.e., x-axis coordinate) and y-coordinate (i.e., y-axis coordinate) of the three-axis motorized stage are controlled by a control unit based on a two-dimensional sketch input.

However, if a vertical position (level) of the three-axis motorized stage is changed due to a change in the working space, etc., the control unit may not quickly control a z-coordinate (i.e., z-axis coordinate) and a base of a sealing system may not be maintained in a completely flat state, i.e., parallel to a ground surface.

In this case, during manufacturing of the rehabilitation device, too high a normal force may be applied to the base, while the corresponding portion is not completely sealed due to a reduction in a vertical force at a tip in an inclined surface, causing a defect such as burning or tearing. In a worst case scenario, permanent damage to the corresponding component may occur. In order to solve this problem, in the manufacturing system of the present embodiment, a linear guide and a spring are attached to a mounting block to provide a passive compliance of the z-axis to the sealing tip. The linear guide only allows vertical movement of the end effector and reacts quickly on uneven surfaces. The pre-tensioned spring helps the end effector apply a relatively constant pressure to a fabric substrate, i.e., a substrate on which the fabric is located, in the z-axis. Due to this, robustness and consistency of sealing are improved.

There are several parameters that determine quality of a sealing pattern. These parameters may be a sealing rate, a temperature of a heating element, and an initial height of the end effector in the z axis.

In this embodiment, a parameter for enhancing the robustness of the rehabilitation band may be found using the Taguchi method.

Initial parameters with three levels are shown in an L₉(3⁴) orthogonal array.

Initially, a linear pattern having a length of 30 mm was produced as test samples (#1 to #9) of a rehabilitation band, and a total of 9 samples were produced. Thereafter, for each sample, a test was performed on several parameters as shown in [Table 1].

TABLE 1
L₉(3⁴) ORTHOGONAL ARRAY FOR THE FIRST TEST SET

| | Sealing Speed | Temperature | | S/N Ratio |
|---|---|---|---|---|
| Test Sample No. | (mm/min) | (° C.) | Z-value | (dB) |
| #1 | 150 | 350 | 2 | 22.28 |
| #2 | 150 | 300 | 3 | 13.62 |
| #3 | 150 | 250 | 4 | 13.06 |
| #4 | 100 | 350 | 3 | 23.75 |
| #5 | 100 | 300 | 4 | 18.17 |
| #6 | 100 | 250 | 2 | 10.37 |
| #7 | 50 | 350 | 4 | 24.30 |
| #8 | 50 | 300 | 2 | 19.28 |
| #9 | 50 | 250 | 4 | 10.88 |

Thereafter, a peeling test for an adhesion test is performed after heat sealing on the samples with a motorized tensile test stand (Mark-10, ESM303).

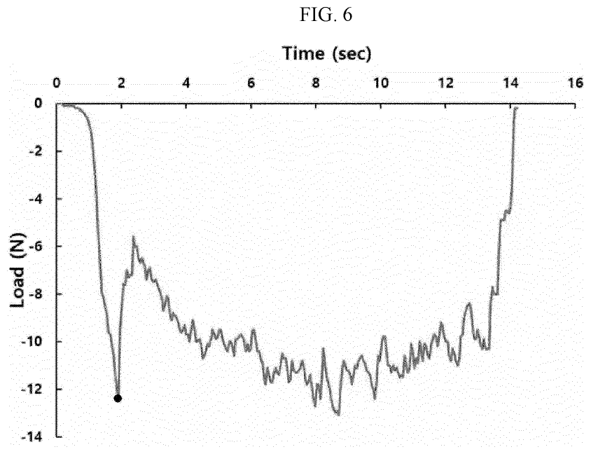

Since the inflatable rehabilitation band loses its functionality when air leakage starts, an initial peak value of a load is determined as a quality characteristic value (FIG. 6). This means that the sealing robustness increases as the initial peak value of the load increases.

Therefore, a signal-to-noise ratio (S/N) shown in [Equation 1] below is calculated by applying Taguchi's larger-the-better theorem.

$$S / N ratio = 10 \cdot log \frac{1}{n} ( {\sum }_{n}^{i = 1} \frac{1}{{y}_{i}^{2}} ) \qquad [ Equation 1 ]$$

(Here, y1 is the quality characteristic value and n is the number of tests.)

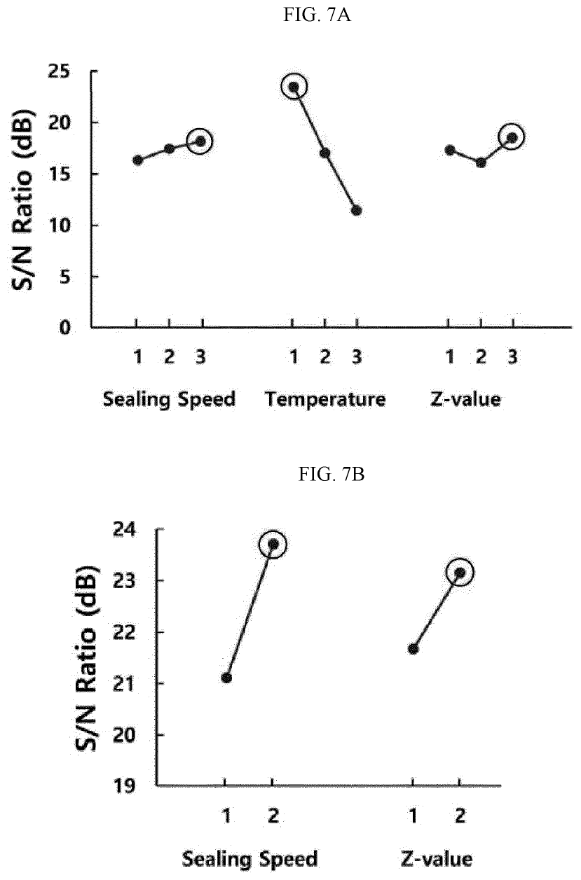

As shown in FIG. 7B, a test level with the highest signal-to-noise ratio (S/N) was selected for a second test set.

Table 2 summarizes the parameters for the test samples for the second test set.

TABLE 2
L₄(2³) ORTHOGONAL ARRAY FOR THE SECOND TEST SET

| | Z-value | Sealing Speed | S/N Ratio |
|---|---|---|---|
| Test Sample No. | (mm) | (mm/min) | (dB) |
| #1 | 4 | 50 | 20.42 |
| #2 | 4 | 40 | 22.92 |
| #3 | 4.5 | 50 | 21.80 |
| #4 | 4.5 | 40 | 24.51 |

A temperature was set at about 350 degrees because the test samples formed of fabric may be burnt at high temperatures. The orthogonal design was changed to L₄(2³) due to physical limitations on other parameters. As a result of the test, a sealing speed, a temperature, and a z value which is a height of the iron are determined to be 40 mm/min, 350 degrees, and 4.5 mm, respectively (see FIG. 7B).

Hereinafter, the test results for the rehabilitation band, i.e., the actuator, according to the present embodiment will be described.

A. Characterization

Characterization test was conducted to obtain a relationship between a contractile force and a length of the actuator (i.e., the rehabilitation bend) and a relationship between forearm rotation and torque of wearable equipment (i.e., the rehabilitation device of this embodiment).

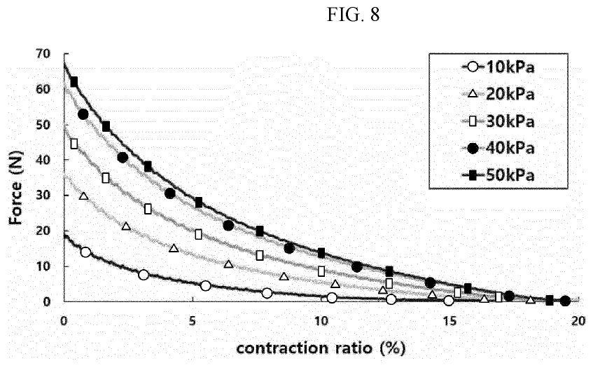

In a first test, tension between two ends of the actuator as a length of the actuator decreased under 5 different pressure levels (10, 20, 30, 40 and 50 kPa) was measured using a motorized test stand (Mark-10, ESM303). Like other pneumatic actuators, as the length of the actuator of this embodiment was shorter, the contractile force decreased (see FIG. 8).

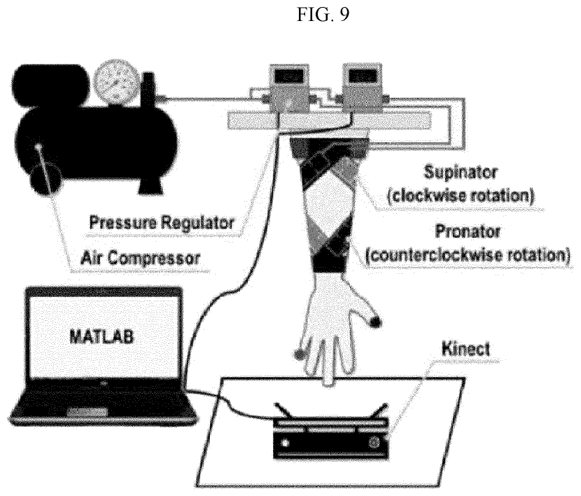

In a second test, a torque sensor (RFT60-HA01, ROBOTUS) and an encoder (SME360CAP-12, SERA) were mounted on a bottom of an aluminum structure, and an arm model was rotated along a shaft of the encoder (FIG. 9).

Since the arm was attached only to the shaft of the encoder, there was no mechanical resistance during rotation.

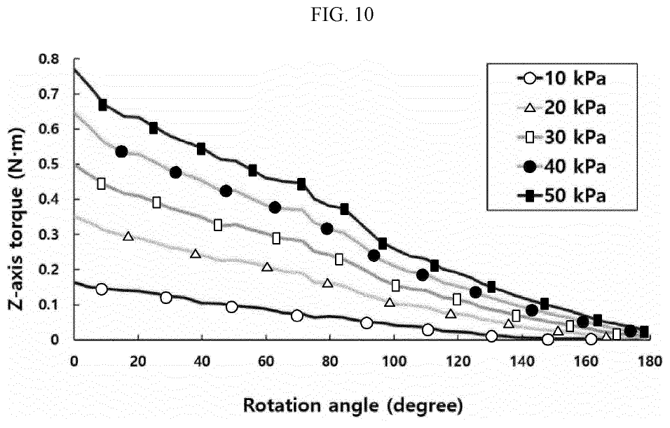

After fixing a hand to a wrist rest shown in FIG. 9, the actuator was inflated and torque was measured with a force-torque sensor at the top of an arm setup. A radius of an upper part of the arm where the force was applied was 4.14 cm. Z-axis torque was measured at five different pressure levels (10, 20, 30, 40 and 50 kPa) by rotating the arm 180 degrees in 5 degrees increments. Referring to the graph of FIG. 10, it is shown that the torque approaches zero (0) when the arm angle reaches 180 degrees. It is shown that, since the actuator was designed to rotate up to 180 degrees, it is rational for two ends of the actuator to act as pivot points.

B. Position Control with Vision Feedback

Position control was tested to assess a possibility of helping rotation motion of the forearm while the user, i.e., the rehabilitating person, is unable to reach his desired position.

Through the characteristic results, pressure of each actuator was calculated by force equilibrium. Since the characterized data are discrete, linear interpolation was used. Since the user's muscles may interfere with a desired motion of the rehabilitation device, the device was tested with closed-loop control in addition to open-loop control.

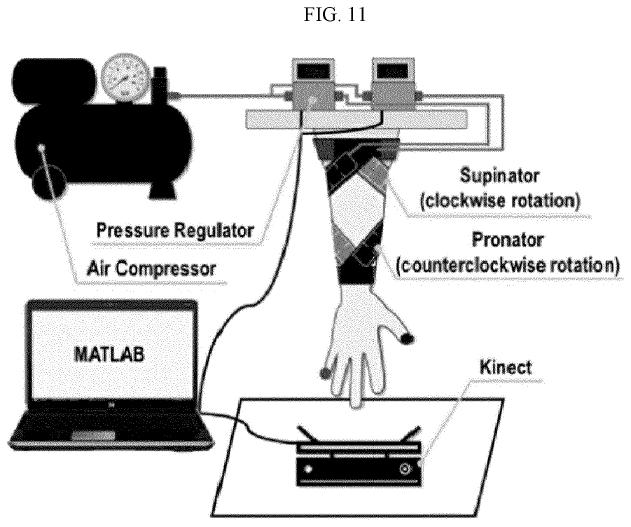

A vision system including RGB and infrared cameras (Kinect) was set up to collect angle changes of the forearm. In order to process vision data obtained by the vision system, a control unit equipped with an optical program such as MATLAB was used. As shown in FIG. 11, the vision system was placed on the ground and the arm model was rotated thereon.

A trace was planned at a speed of 360 degrees/min. To reach a target angle, two actuators (e.g., the first and second rehabilitation bands) must reach force equilibrium. According to the existing test results, the force decreases non-linearly as the rotation angle increases. When a rotation angle of the first actuator is determined, a rotation angle of the other actuator may be an angle obtained by subtracting the angle of the first actuator from 180 degrees. Thereafter, different air pressures are supplied to the actuator to reach force equilibrium.

During the closed loop, circular markers were respectively marked on the thumb and little finger of the arm model as shown in FIG. 11. A sampling rate of vision data was about 6 Hz. The control unit recognized the two circular markers as points and measured an angle between lines formed by connecting the horizontal lines and the two points. Here, proportional control was applied to simplify control.

The result that the arm model rotates by a desired angle to follow the desired angle is shown. At angles from 40 degrees to 140 degrees, a root-mean-square error (RMSE) between the desired angle and an adjusted angle was about 7.83 degrees. In this test, a small proportional gain was set to avoid oscillation. As a result, the controlled angle generally followed the desired angle. However, a relatively large error occurred in a small angle and a large angle range (0 degrees to 40 degrees and 140 degrees to 180 degrees). When the actuator was fully contracted, the actuator produced weak torque, but such weak torque was overcome by torque of the opposite actuator with little input air pressure. Considering this problem, a longer actuator than the actuator in the test example is preferred.

Since the test setting is symmetrical, control in the opposite direction may be done in the same manner.

As described above, the rehabilitation device of this embodiment is a soft and lightweight wearable rehabilitation device formed of a lightweight fabric inflatable structure inspired by the human musculoskeletal system.

In addition, due to the manufacturing using the three-axis heat sealing system, the rehabilitation device of this embodiment ensures robustness and safety, and reliability of the operation of the rehabilitation device is enhanced by searching the parameters for the reliability of the operation.

In addition, the rehabilitation device of this embodiment was subjected to the test on characterization and position control to verify feasibility. The rehabilitation device of this embodiment has advantages in compliance, safety, cost efficiency, and light weight compared to the existing heavy and expensive rehabilitation device.

Silicone pads and friction-resistant materials were currently selected for the devices, but these devices slipped on the skin when supplied with high air pressure.

In addition, since the rehabilitation device of this embodiment is easily worn on the forearm without slipping by the first and second fixing bands worn on the upper and lower part of the forearm, the wearability is improved and the rehabilitation device is easy to use.

In addition, due to the anti-slip pad containing a synthetic resin material such as silicone, the wearability of the rehabilitation device of the present embodiment is further improved, and a phenomenon that the rehabilitation device is separated or slips off the body part during operation is further prevented.

The rehabilitation device of the present embodiment may be used with a rehabilitation device of other body parts (e.g., upper limb) and may be integrally manufactured.

The present disclosure has been described. The present disclosure is not limited to the embodiments described and the accompanying drawings, and various modifications and variations may be made from the viewpoint of a person skilled in the art to which the present invention pertains. Therefore, the scope of the present invention should be defined by the equivalents of claims of the present disclosure as well as the claims.

What is claimed is:

1. A pneumatic inflatable rehabilitation device comprising:
a first fixing band mounted on an upper part of a forearm;
a second fixing band mounted on a lower part of the forearm; and
at least one rehabilitation band having one side and the other side mounted between the first fixing band and the second fixing band and wound around the forearm at least once.

2. The pneumatic inflatable rehabilitation device of claim 1, wherein
the rehabilitation band comprises:
a body filled with air injected from the outside; and
an attachment portion located at opposing ends of the body and mounted at each of the first and second fixing bands.

3. The pneumatic inflatable rehabilitation device of claim 2, wherein
the body comprises a plurality of air chambers partitioned along a longitudinal direction and each filled with air.

4. The pneumatic inflatable rehabilitation device of claim 3, wherein
two adjacent air chambers are connected to each other.

5. The pneumatic inflatable rehabilitation device of claim 2, wherein
an end of the attachment portion has a diagonal structure.

6. The pneumatic inflatable rehabilitation device of claim 5, wherein
the opposing ends of the body has an oblique structure.

7. The pneumatic inflatable rehabilitation device of claim 2, wherein
the attachment portion has a Velcro structure.

8. The pneumatic inflatable rehabilitation device of claim 2, wherein
the rehabilitation band further comprises an air injection port connected to one side of the body.

9. The pneumatic inflatable rehabilitation device of claim 1, wherein
the rehabilitation band is provided as two rehabilitation bands.

10. The pneumatic inflatable rehabilitation device of claim 1, wherein
the first fixing band and the second fixing band each comprise:
a body; and
a fixing portion connected to an end of the body.

11. The pneumatic inflatable rehabilitation device of claim 10, wherein
the body of each of the first fixing band and the second fixing band comprises an anti-slip pad.

12. The pneumatic inflatable rehabilitation device of claim 10, wherein
each of outer surfaces of the body of the first fixing band and the body of the second fixing band has a Velcro structure.

13. The pneumatic inflatable rehabilitation device of claim 10, wherein
the fixing portion of the first fixing band and the fixing portion of the second fixing band each comprise:
a fixing strap; and
a fixing ring coupled to the fixing strap.

14. The pneumatic inflatable rehabilitation device of claim 1, wherein
the pneumatic inflatable rehabilitation device includes fabric.
